(19) United States
(12) Patent Application Publication
(10) Pub. No.: US 2008/0276266 A1
(43) Pub. Date: Nov. 6, 2008

(54) CHARACTERIZING CONTENT FOR IDENTIFICATION OF ADVERTISING

(75) Inventors: Jill A. Huchital, Saratoga, CA (US); Gregory Joseph Badros, Palo Alto, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/737,038

(22) Filed: Apr. 18, 2007

(51) Int. Cl. H04N 7/025

(52) U.S. Cl. 725/32

(57) ABSTRACT

Methods, systems, and apparatus, including computer program products, for characterizing content for content targeting. A first content item is received. One or more content boundaries are determined for the first content item. The content boundaries segment the first content item into a plurality of segments. One or more respective targeting criteria are determined for at least one segment. One or more second content items are identified for a respective content boundary based on the targeting criteria for one or more of the segments preceding or succeeding the respective content boundary. Access to the identified second content items is provided for presentation or storage on a device.

### BACKGROUND

This specification relates to advertising.

Online video is a growing medium. The popularity of online video services reflect this growth. Advertisers see online video as another way to reach their customers. Many advertisers are interested in maximizing the number of actions (e.g., impressions and/or click-throughs) for their advertisements. To achieve this, advertisers make efforts to target advertisements to content, such as videos, that are relevant to their advertisements.

When an advertiser wishes to target advertisements to a video, the advertiser targets the advertisements to the video as a whole. For example, if videos are classified into categories, the advertiser can target advertisements to the videos based on the categories.

However, the subject matter of a video can change throughout the video. An advertisement that is targeted to the video as whole may not be relevant for the entire duration of the video.

### SUMMARY

In general, one aspect of the subject matter described in this specification can be embodied in methods that include the actions of receiving a first content item; determining one or more content boundaries for the first content item, the content boundaries segmenting the first content item into a plurality of segments; determining, for at least one segment, one or more respective targeting criteria; identifying one or more second content items for a respective content boundary based on the targeting criteria for one or more of the segments preceding or succeeding the respective content boundary; and providing access to the identified second content items for presentation or storage on a device. Other embodiments of this aspect include corresponding systems, apparatus, and computer program products.

In general, one aspect of the subject matter described in this specification can be embodied in methods that include the actions of receiving a first content item, where the first content item is segmented into a plurality of segments by one or more content boundaries and at least one segment is associated with respective targeting criteria; identifying, for a respective content boundary, one or more second content items based on the respective advertisement targeting criteria associated with one or more of the segments preceding or succeeding the respective content boundary; and providing access to the identified second content items for presentation or storage on a device. Other embodiments of this aspect include corresponding systems, apparatus, and computer program products.

In general, one aspect of the subject matter described in this specification can be embodied in methods that include the actions of receiving a first content item, where the first content item is segmented into a plurality of segments by one or more content boundaries and at least one segment is associated with respective targeting criteria; presenting the first content item; requesting, for a respective content boundary, one or more second content items associated with respective targeting criteria of one or more of the segments preceding or succeeding the respective content boundary; receiving the second content items; and presenting on a device the second content items after the content boundary is reached during the presenting of the first content item. Other embodiments of this aspect include corresponding systems, apparatus, and computer program products.

Particular embodiments of the subject matter described in this specification can be implemented to realize none, one or more of the following advantages. A content item that includes video and/or audio data can be segmented into one or more segments. Targeting criteria can be determined on a segment-by-segment basis. Using the segment targeting criteria, other content (e.g., advertisements, related content) can be targeted to particular segments or combinations of segments of the content item.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of an environment for providing content.

FIG. 2 is a block diagram illustrating an example environment in which electronic promotional material (e.g., advertising content) may be identified according to targeting criteria.

FIG. 3 is a flow diagram illustrating an example process for providing advertising content based on a proximity to a boundary in a content item.

FIG. 4 is a flow diagram illustrating an example process for providing advertising content based on targeting criteria.

FIG. 5 is a flow diagram illustrating an example process for presenting requested advertising content.

FIG. 6 is a flow diagram illustrating an example process for selecting a mode of display for advertising content.

FIG. 7A is an example content item timeline illustrating segments of a content item.

FIG. 7B is an example table of content item segments and associated targeting criteria.

FIG. 8 is an example user interface for displaying content.

FIG. 9 is an example user interface of a video player region.

FIG. 10 is a block diagram illustrating an example generic computer and an example generic mobile computer device.

### DETAILED DESCRIPTION

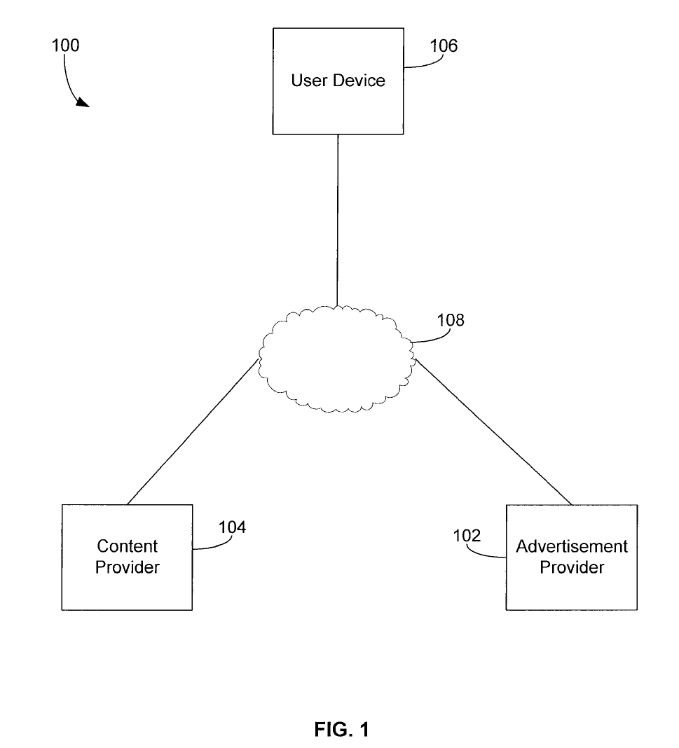

FIG. 1 shows an example of an environment 100 for providing content. The content, or “content items,” can include various forms of electronic media. For example, the content can include text, audio, video, advertisements, configuration parameters, documents, video files published on the Internet, television programs, podcasts, video podcasts, live or recorded talk shows, video voicemail, segments of a video conversation, and other distributable resources.

The environment 100 includes, or is communicably coupled with, an advertisement provider 102, a content provider 104, and one or more user devices 106, at least some of which communicate across network 108. In general, the advertisement provider 102 can characterize hosted content and provide relevant advertising content (“ad content”) or other relevant content. For example, the hosted content may be provided by the content provider 104 through the network 108. The ad content may be distributed, through network 108, to one or more user devices 106 before, during, or after presentation of the hosted material. In some implementations, advertisement provider 102 may be coupled with one or more advertising repositories (not shown). The repositories store advertising that can be presented with various types of content, including audio and/or video content.

In some implementations, the environment 100 may be used to identify relevant advertising content according to a particular selection of a video or audio content item (e.g., one or more segments of video or audio). For example, the advertisement provider 102 can acquire knowledge about scenes in a video content item, such as content changes in the audio and video data of the video content item. The knowledge can be used to determine targeting criteria for the video content item, which in turn can be used to select relevant advertisements for appropriate places in the video content item. In some implementations, the relevant advertisements can be placed in proximity to the video content item, such as in a banner, sidebar, or frame.

In some implementations, a “video content item” is an item of content that includes content that can be perceived visually when played, rendered, or decoded. A video content item includes video data, and optionally audio data and metadata. Video data includes content in the video content item that can be perceived visually when the video content item is played, rendered, or decoded. Audio data includes content in the video content item that can be perceived aurally when the video content item is played, decoded, or rendered. A video content item may include video data and any accompanying audio data regardless of whether or not the video content item is ultimately stored on a tangible medium. A video content item may include, for example, a live or recorded television program, a live or recorded theatrical or dramatic work, a music video, a televised event (e.g., a sports event, a political event, a news event, etc.), video voicemail, etc. Each of different forms or formats of the same video data and accompanying audio data (e.g., original, compressed, packetized, streamed, etc.) may be considered to be a video content item (e.g., the same video content item, or different video content items).

Video content can be consumed at various client locations, using various devices. Examples of the various devices include customer premises equipment which is used at a residence or place of business (e.g., computers, video players, video-capable game consoles, televisions or television set-top boxes, etc.), a mobile telephone with video functionality, a video player, a laptop computer, a set top box, a game console, a car video player, etc. Video content may be transmitted from various sources including, for example, terrestrial television (or data) transmission stations, cable television (or data) transmission stations, satellite television (or data) transmission stations, via satellites, and video content servers (e.g., Webcasting servers, podcasting servers, video streaming servers, video download Websites, etc.), via a network such as the Internet for example, and a video phone service provider network such as the Public Switched Telephone Network (“PSTN”) and the Internet, for example.

A video content item can also include many types of associated data. Examples of types of associated data include video data, audio data, closed-caption or subtitle data, a transcript, content descriptions (e.g., title, actor list, genre information, first performance or release date, etc.), related still images, user-supplied tags and ratings, etc. Some of this data, such as the description, can refer to the entire video content item, while other data (e.g., the closed-caption data) may be temporally-based or timecoded. In some implementations, the temporally-based data may be used to detect scene or content changes to determine relevant portions of that data for targeting ad content to users.

In some implementations, an “audio content item” is an item of content that can be perceived aurally when played, rendered, or decoded. An audio content item includes audio data and optionally metadata. The audio data includes content in the audio content item that can be perceived aurally when the video content item is played, decoded, or rendered. An audio content item may include audio data regardless of whether or not the audio content item is ultimately stored on a tangible medium. An audio content item may include, for example, a live or recorded radio program, a live or recorded theatrical or dramatic work, a musical performance, a sound recording, a televised event (e.g., a sports event, a political event, a news event, etc.), voicemail, etc. Each of different forms or formats of the audio data (e.g., original, compressed, packetized, streamed, etc.) may be considered to be an audio content item (e.g., the same audio content item, or different audio content items).

Audio content can be consumed at various client locations, using various devices. Examples of the various devices include customer premises equipment which is used at a residence or place of business (e.g., computers, audio players, audio-capable game consoles, televisions or television set-top boxes, etc.), a mobile telephone with audio playback functionality, an audio player, a laptop computer, a car audio player, etc. Audio content may be transmitted from various sources including, for example, terrestrial radio (or data) transmission stations, via satellites, and audio content servers (e.g., Webcasting servers, podcasting servers, audio streaming servers, audio download Websites, etc.), via a network such as the Internet for example, and a video phone service provider network such as the Public Switched Telephone Network (“PSTN”) and the Internet, for example.

An audio content item can also include many types of associated data. Examples of types of associated data include audio data, a transcript, content descriptions (e.g., title, actor list, genre information, first performance or release date, etc.), related album cover image, user-supplied tags and ratings, etc. Some of this data, such as the description, can refer to the entire audio content item, while other data (e.g., the transcript data) may be temporally-based. In some implementations, the temporally-based data may be used to detect scene or content changes to determine relevant portions of that data for targeting ad content to users.

Ad content can include text, graphics, video, audio, banners, links, and other web or television programming related data. As such, ad content can be formatted differently, based on whether it is primarily directed to websites, media players, email, television programs, closed captioning, etc. For example, ad content directed to a website may be formatted for display in a frame within a web browser. As another example, ad content directed to a video player may be presented “in-stream” as video content is played in the video player. In some implementations, in-stream ad content may replace the video or audio content in a video or audio player for some period of time or inserted between portions of the video or audio content. An in-stream ad can be pre-roll, post-roll, or interstitial. An in-stream ad may include video, audio, text, animated images, still images, or some combination thereof.

The content provider 104 can present content to users (e.g., user device 106) through the network 108. In some implementations, the content providers 104 are web servers where the content includes webpages or other content written in the Hypertext Markup Language (HTML), or any language suitable for authoring webpages. In general, content provider 104 can include users, web publishers, and other entities capable of distributing content over a network. For example, a web publisher may create an MP3 audio file and post the file on a publicly available web server. In some implementations, the content provider 104 may make the content accessible through a known Uniform Resource Locator (URL).

The content provider 104 can receive requests for content (e.g., articles, discussion threads, music, audio, video, graphics, search results, webpage listings, etc.). The content provider 104 can retrieve the requested content in response to, or otherwise service, the request. The advertisement provider 102 may broadcast content as well (e.g., not necessarily responsive to a request).

A request for advertisements (or “ads”) may be submitted to the advertisement provider 102. Such an ad request may include ad spot information (e.g., a number of ads desired, a duration, type of ads eligible, etc.). In some implementations, the ad request may also include information about the content item that triggered the request for the advertisements. This information may include the content item itself (e.g., a page, a video file, a segment of an audio stream, data associated with the video or audio file, etc.), one or more categories or topics corresponding to the content item or the content request (e.g., arts, business, computers, arts-movies, arts-music, etc.), part or all of the content request, content age, content type (e.g., text, graphics, video, audio, mixed media, etc.), geo-location information, etc.

Content provided by content provider 104 can include news, weather, entertainment, or other consumable textual, audio, or video media. More particularly, the content can include various resources, such as documents (e.g., webpages, plain text documents, Portable Document Format (PDF) documents, images), video or audio clips, etc. In some implementations, the content can be graphic-intensive, media-rich data, such as, for example, Flash-based content that presents video and sound media.

The environment 100 includes one or more user devices 106. The user device 106 can include a desktop computer, laptop computer, a media player (e.g., an MP3 player, a streaming audio player, a streaming video player, a television, a computer, a mobile device, etc.), a mobile phone, a browser facility (e.g., a web browser application), an e-mail facility, telephony means, a set top box, a television device or other computing device that can access advertisements and other content via network 108. The content provider 104 may permit user device 106 to access content (e.g., video files, audio files, etc.).

The network 108 facilitates wireless or wireline communication between the advertisement provider 102, the content provider 104, and any other local or remote computers (e.g., user device 106). The network 108 may be all or a portion of an enterprise or secured network. In another example, the network 108 may be a virtual private network (VPN) between the content provider 104 and the user device 106 across a wireline or a wireless link. While illustrated as a single or continuous network, the network 108 may be logically divided into various sub-nets or virtual networks without departing from the scope of this disclosure, so long as at least a portion of the network 108 may facilitate communications between the advertisement provider 102, content provider 104, and at least one client (e.g., user device 106). In certain implementations, the network 108 may be a secure network associated with the enterprise and certain local or remote clients 106.

Examples of network 108 include a local area network (LAN), a wide area network (WAN), a wireless phone network, a Wi-Fi network, and the Internet.

In some implementations, a content item is combined with one or more of the advertisements provided by the advertisement provider 102. This combined information including the content of the content item and advertisement(s) is then forwarded toward a user device 106 that requested the content item or that configured itself to receive the content item, for presentation to a user.

The content provider 104 may transmit information about the ads and how, when, and/or where the ads are to be rendered, and /or information about the results of that rendering (e.g., ad spot, specified segment, position, selection or not, impression time, impression date, size, temporal length, volume, conversion or not, etc.) back to the advertisement provider 102 through the network 108. Alternatively, or in addition, such information may be provided back to the advertisement provider 102 by some other means.

In some implementations, the content provider 104 includes advertisement media as well as other content. In such a case, the advertisement provider 102 can determine and inform the content provider 104 which advertisements to send to the user device 106, for example.

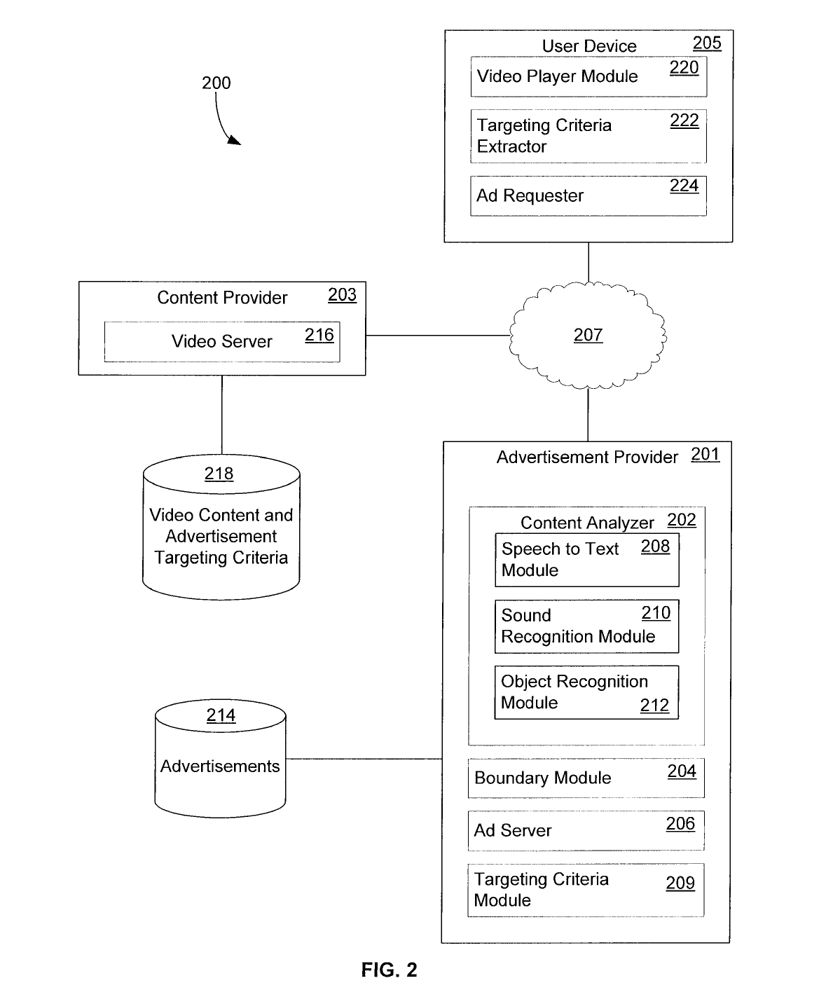

FIG. 2 is a block diagram illustrating an example environment 200 in which electronic promotional material (e.g., advertising content or advertisements) may be identified according to targeting criteria. Environment 200 includes, or is communicatively coupled with advertisement provider 201, content provider 203, and user device 205, at least some of which communicate across network 207.

In some implementations, the advertisement provider 201 includes a content analyzer 202, a boundary module 204, and an ad server 206. The content analyzer 202 may examine received content items to determine segmentation boundaries and/or targeting criteria for content items. For example, the content analyzer 202 may implement various analysis methods, including, but not limited to weighting schemes, speech processing, image or object recognition, and statistical methods.

The analysis methods can be applied to the contextual elements of the received content item (e.g., video content, audio content, etc.) to determine boundaries for segmenting the received content and to determine relevant targeting criteria. For example, the received content may undergo one or more of audio volume normalization, automatic speech recognition, transcoding, indexing, image recognition, sound recognition, etc. In some implementations, the content analyzer 202 includes a speech to text module 208, a sound recognition module 210, and an object recognition module 212. Other modules are possible.

The speech to text module 208 can analyze content received in environment 200 to identify speech in the content. For example, a video content item may be received in the environment 200. The speech-to-text module 208 can analyze the video content item as a whole. Textual information may be derived from the speech included in the audio data of the video content item by performing speech recognition on the audio content, producing in some implementations hypothesized words annotated with confidence scores, or in other implementations a lattice which contains many hypotheses. Examples of speech recognition techniques include techniques based on hidden Markov models, dynamic programming, or neural networks.

In some implementations, the speech analysis may include identifying phonemes, converting the phonemes to text, interpreting the phonemes as words or word combinations, and providing a representation of the words, and/or word combinations, which best corresponds with the received input speech (e.g., speech in the audio data of a video content item). The text can be further processed to determine the subject matter of the video content item. For example, keyword spotting (e.g., word or utterance recognition), pattern recognition (e.g., defining noise ratios, sound lengths, etc.), or structural pattern recognition (e.g., syntactic patterns, grammar, graphical patterns, etc.) may be used to determine the subject matter, including different segments, of the video content item. The identified subject matter in the video content item content can be used to identify boundaries for dividing the video content item into segments and to identify relevant targeting criteria. In some implementations, further processing may be carried out on the video content item to refine the identification of subject matter in the video content item.

A video content item can also include timecoded metadata. Examples of timecoded metadata include closed-captions, subtitles, or transcript data that includes a textual representation of the speech or dialogue in the video or audio content item. In some implementations, a caption data module at the advertisement provider 201 (not shown) extracts the textual representation from the closed-caption, subtitle, or transcript data of the content item and used the extracted text to identify subject matter in the video content item. The extracted text can be a supplement to or a substitute for application of speech recognition on the audio data of the video content item.

Further processing may include sound recognition techniques performed by the sound recognition module 210. Accordingly, the sound recognition module 210 may use sound recognition techniques to analyze the audio data. Understanding the audio data may enable the environment 200 to identify the subject matter in the audio data and to identify likely boundaries for segmenting the content item. For example, the sound recognition module 210 may recognize abrupt changes in the audio or periods of silence in the video, which may be indicia of segment boundaries.

Further processing of received content can also include object recognition. For example, automatic object recognition can be applied to received or acquired video data of a video content item to determine targeting criteria for one or more objects associated with the video content item. For example, the object recognition module 212 may automatically extract still frames from a video content item for analysis. The analysis may identify targeting criteria relevant to objects identified by the analysis. The analysis may also identify changes between sequential frames of the video content item that may be indicia of different scenes (e.g., fading to black). If the content item is an audio content item, then object recognition analysis is not applicable (because there is no video content to analyze). Examples of object recognition techniques include appearance-based object recognition, and object recognition based on local features, an example of which is disclosed in Lowe, “Object Recognition from Local Scale-Invariant Features,” Proceedings of the Seventh IEEE International Conference on Computer Vision, Volume 2, pp. 1150-1157 (September 1999).

Advertisement provider 201 includes a boundary module 204. The boundary module 204 may be used in conjunction with the content analyzer 202 to place boundaries in the content received at the advertisement provider 201. The boundaries may be placed in text, video, graphical, or audio data based on previously received content. For example, a content item may be received as a whole and the boundaries may be applied based on the subject matter in the textual, audio, or video content. In some implementations, the boundary module 204 may simply be used to interpret existing boundary settings for a particular selection of content (e.g., a previously aired television program). In some implementations, the boundary data are stored separately from the content item (e.g., in a separate text file).

Advertisement provider 201 includes a targeting criteria module 209. The targeting criteria module 209 may be used in conjunction with the content analyzer 202 to identify targeting criteria for content received at the advertisement provider 201. The targeting criteria can include keywords, topics, concepts, categories, and the like.

In some implementations, the information obtained from analyses of a video content item performed by the content analyzer 202 can be used by both the boundary module 204 and the targeting criteria module 209. Boundary module 204 can use the information (e.g., recognized differences between frames, text of speech in the video content item, etc.) to identify multiple scenes in the video content item and the boundaries between the scenes. The boundaries segment the video content item into segments, for which the targeting criteria module 209 can use the same information to identify targeting criteria.

Advertisement provider 201 also includes an ad server 206. Ad server 206 may directly, or indirectly, enter, maintain, and track ad information. The ads may be in the form of graphical ads such as so-called banner ads, text only ads, image ads, audio ads, video ads, ads combining one of more of any of such components, etc. The ads may also include embedded information, such as a link, and/or machine executable instructions. User devices 205 may submit requests for ads to, accept ads responsive to their request from, and provide usage information to, the ad server 206. An entity other than a user device 205 may initiate a request for ads. Although not shown, other entities may provide usage information (e.g., whether or not a conversion or selection related to the ad occurred) to the ad server 206. For example, this usage information may include measured or observed user behavior related to ads that have been served.

The ad server 206 may include information concerning accounts, campaigns, creatives, targeting, etc. The term “account” relates to information for a given advertiser (e.g., a unique email address, a password, billing information, etc.). A “campaign,” “advertising campaign,” or “ad campaign” refers to one or more groups of one or more advertisements, and may include a start date, an end date, budget information, targeting information, syndication information, etc.

In some implementations, the advertisement provider 201 may receive content from the content provider 203. The techniques and methods discussed in the above description may be applied to the received content. The advertisement provider 201 can then provide advertising content to the content provider 203 that corresponds to the received/analyzed content.

The advertisement provider 201 may use one or more advertisement repositories 214 for selecting ads for presentation to a user or other advertisement providers. The repositories 214 may include any memory or database module and may take the form of volatile or non-volatile memory including, without limitation, magnetic media, optical media, random access memory (RAM), read-only memory (ROM), removable media, or any other suitable local or remote memory component.

The content provider 203 includes a video server 216. The video server 216 may be thought of, generally, as a content server in which the content served is simply a video content item, such as a video stream or a video file for example. Further, video player applications may be used to render video files. Ads may be served in association with video content items. For example, one or more ads may be served before, during, or after a music video, program, program segment, etc. Alternatively, one or more ads may be served in association with a music video, program, program segment, etc. In implementations where audio-only content items can be provided, the video server 216 can be an audio server instead, or more generally, a content server can serve video content items and audio content items.

The content provider 203 may have access to various content repositories. For example, the video content and advertisement targeting criteria repository 218 may include available video content items (e.g., video content items for a particular website) and their corresponding targeting criteria. In some implementations, the advertisement provider 201 analyzes the material from the repository 218 and determines the targeting criteria for the received material. This targeting criteria can be correlated with the material in the video server 216 for future usage, for example. In some implementations, the targeting criteria for a content item in the repository is associated with a unique identifier of the content item.

In operation, the advertisement provider 201 and the content provider 203 can both provide content to a user device 205. The user device 205 is one example of an ad consumer. The user device 205 may include a user device such as a media player (e.g., an MP3 player, a streaming audio player, a streaming video player, a television, a computer, a mobile device, etc.), a browser facility, an e-mail facility, telephony means, etc.

As shown in FIG. 2, the user device 205 includes a video player module 220, a targeting criteria extractor 222, and an ad requester 224. The video player module 220 can execute documents received in the system 106. For example, the video player module 220 can play back video files or streams. In some implementations, the video player module 220 is a multimedia player module that can play back video files or streams and audio files or streams.

In some implementations, when the user device 205 receives content from the content provider (e.g., video, audio, textual content), the targeting criteria extractor 222 can receive corresponding metadata. The metadata includes targeting criteria. The targeting criteria extractor 222 extracts the targeting criteria from the received metadata. In some implementations, the targeting criteria extractor 222 can be a part of the ad requester 224. In this example, the ad requestor 224 extracts the targeting criteria form the metadata. The extracted targeted criteria can be combined with targeting criteria derived from other sources (e.g., web browser type, user profile, etc.), if any, and one or more advertisement requests can be generated based on the targeting criteria.

In some other implementations, the metadata, which includes targeting criteria, is received by the user device. A script for sending a request can be run by the ad requester 224. The script operates to send a request using the received targeting criteria, without necessarily extracting the targeting criteria from the metadata.

The ad requester 224 can also simply perform the ad request using the targeting criteria information. For example, the ad requester 224 may submit a request for ads to the advertisement provider 201. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, metadata information, etc.

In some implementations, content analyzer 202, boundary module 204, and targeting criteria module 209 can be included in the content provider 203. That is, the analysis of content items and determination of boundaries and targeting criteria can take place at the content provider 203.

Although the foregoing examples described servers as (i) requesting ads, and (ii) combining them with content, one or both of these operations may be performed by a user device (e.g., an end user computer, for example).

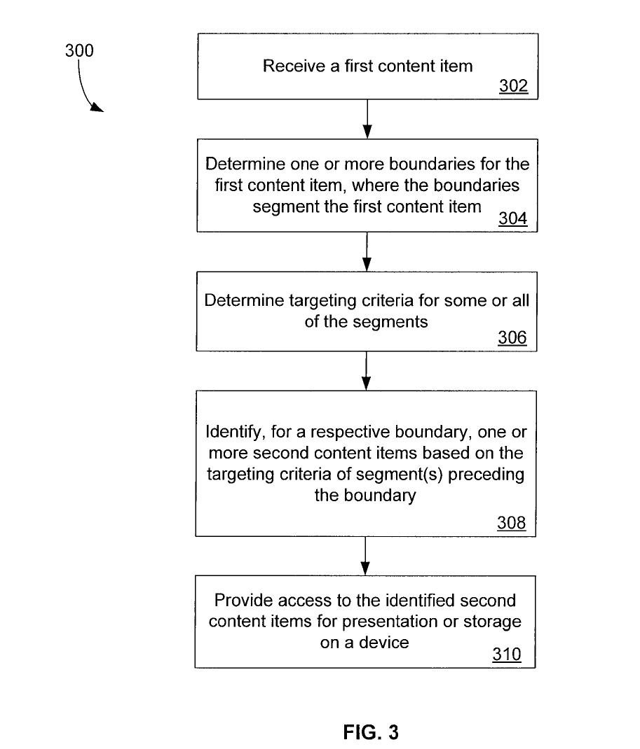

FIG. 3 is a flow diagram illustrating an example process 300 for providing advertising content based on a proximity to a boundary.

A first content item (e.g., a video content item or an audio content item) is received (302). For example, the content item can be received from an upload to the content provider 203 by a creator of the content item or from a content feed. As another example, the content provider 203 can crawl sites that contain content items and receive the content item as a part of the crawl. As a further example, the first content item may be transmitted to the advertisement provider 201 by the content provider. The first content item may include some or all of the following: video data, audio data, closed-captioning or subtitle data, a content description, related images, and so forth.

One or more boundaries are determined for the received first content item (304). The boundaries segment the first content item into two or more segments. The boundary positions may be determined according to length, subject matter, and/or other criteria. The boundary positions may be stored in metadata associated with the content item and indicate the time positions of the boundaries.

In some implementations, the boundaries can be placed according to the time a particular subject matter is covered in the first content item. In some implementations, the boundaries signify the end of one content item and the beginning of another content item. For example, a television broadcast may include content items that span a three hour time period (e.g., prime time television). The three hour time period can be segmented such that boundaries occur between different television programs. The beginning and the end of the content item can be considered boundaries; even though the beginning and the end of the content item do not divide the content item into segments, they can indicate the beginning or end of scenes or segments in the content item.

In some implementations, the first content item is analyzed to determine the different scenes in the first content item and to identify the boundaries between the scenes. The scene boundaries segment the content item into two or more segments. For example, the content item can be analyzed using various techniques (e.g., speech recognition, sound recognition, object recognition, etc.) to determine the positions of the boundaries.

In some implementations, content slots (e.g., advertisement slots) can be inserted between segments of the content item, at the boundary points that are neither the beginning nor the end of the content item. A content slot can be reserved for presentation of in-stream content that is targeted to any number of segments that precede or succeed the content slot. For example, an advertisement slot can be inserted at a boundary between segments of a content item. Interstitial in-stream advertisements can be presented in the advertisement slot when the content item is played back at a user device, for example. Examples of advertisement slots are disclosed in U.S. patent application Ser. No. 11/550,388, titled “Using Viewing Signals In Targeted Video Advertising,” filed Oct. 17, 2006, which is incorporated by reference in its entirety.

For at least one segment, one or more targeting criteria (e.g., advertisement targeting criteria) are determined (306). For example, the advertisement provider 201 can determine the context in which an advertisement can be consumed in order to be relevant and interesting to a particular user. Targeting criteria can include a set of keywords, a set of one or more topics, and other constraints to narrow selection of content targeted to the content item (e.g., advertising material, related videos, etc.). In some implementations, the resulting targeting criteria retains information about when it may be relevant. Accordingly, temporal relevance could be stored either with time code or scene information.

Targeting criteria can be derived from various sources. For example, video and/or audio data from the first content item may be analyzed to derive textual information. The derived textual information may then be analyzed to determine targeting criteria for one or more segments. For example, as discussed with reference to FIG. 2, textual information may be derived from the audio data in an audio or video content item by performing speech recognition on the audio content, producing hypothesized words annotated with confidence scores. Converting audio to text can be achieved by known automatic speech recognition techniques (e.g., techniques based on hidden Markov models, dynamic programming, or neural networks). Other sources of targeting criteria can include, for example, objects recognized in the visual content of the video content item.

In some implementations, the owner or creator of the content item may provide metadata about the content item, from which targeting criteria can be derived. Such metadata may include, for example, one or more of a title, a description, a transcript, a recommended viewing demographic, and others.

In some implementations, the publisher of the content item (or some other entity) may have annotated one or more segments of a content item with textual information or encoded textual information in the video content (e.g., in packets, portions of packets, portions of streams, headers, footers, etc.). In some implementations, a video broadcaster may provide in their broadcast, a station identifier, a program identifier, location information, etc. In this case, genre and location information might be derived from the video broadcast. Such relevance information may be used to derive targeting criteria. As another example, video disks may encode information about a movie such as, for example, title, actors and actresses, directors, scenes, etc. Such information may be used to lookup a textual transcript of the movie. As yet another example, a request for a video may have an associated IP address from which location information can be derived. As yet another example, a program may be annotated with keywords, topics, etc. Such relevance information may be used to derive targeting criteria.

One or more second content items (e.g., advertisements, other content items) are identified for a respective boundary based on the targeting criteria of one or more of the segments preceding or succeeding the boundary (308). In some implementations, the second content items are identified based on only the segment in the content item immediately preceding the boundary. In some other implementations, the second content items are identified based on any number of the segments in the content item that precede or succeed the boundary.

In some implementations, the second content items are identified after a delay from when the targeting criteria are identified (as described in reference to block 306). For example, the targeting criteria can be stored (e.g., in a database) and associated with a unique identifier of the first content item. At a later time (e.g., when the first content item is requested by a user device), the targeting criteria can be retrieved and the second content items can be identified.

Access to the identified second content items is provided for presentation or storage on a device (310). For example, the advertisement provider 201 may provide relevant advertisements to a user device 205 through in-stream video or audio or onscreen in a webpage or media player. In some implementations, advertisements may be provided for each bounded segment. For example, as a video content item is played back, the content may change several times over the course of time.

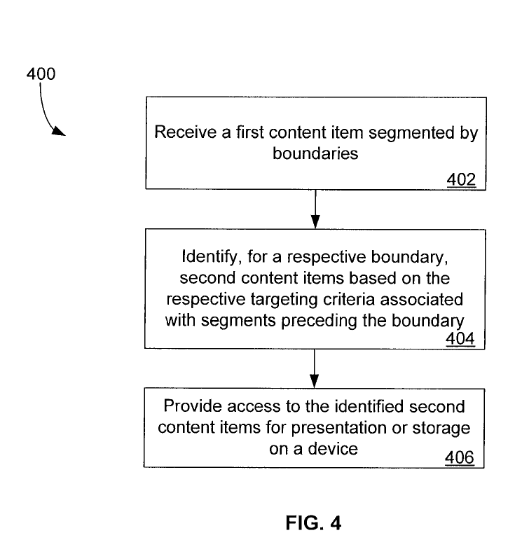

FIG. 4 is a flow diagram illustrating an example process 400 that can be used for providing advertising content based on targeting criteria.

In this example, one or more first content items that have been segmented by boundaries are received (402). In some implementations, the boundaries can include scene boundaries that include “breakpoints” in the type of content presented. The scene boundaries may be associated with scene-dependent targeting criteria. For example, scenes presented in a video podcast can drastically change from one playlist to the next. The boundaries can ensure relevant targeting criteria is used on a per segment basis.

In some other implementations, instead of receiving the first content items, unique identifiers of the first content items are received. The identifiers can be used to retrieve the targeting criteria of the content items referenced by the identifiers from a data store (e.g., targeting criteria repository 218).

In some implementations, the targeting criteria imposed on a particular segment can be used to identify one or more second content items (e.g., another video podcast, podcast, or advertisement). The targeting criteria can be associated with the segment of data preceding or succeeding a boundary. The system can use the metadata in any number of segments preceding or succeeding the boundary to identify a second content item (e.g., video audio, advertisement, etc.) for example (404).

As another example, a television program depicting makeovers for contestants may include dental product advertisements for a commercial break following a scene depicting a cosmetic dentistry appointment. The dental product advertisement may have been selected for play in that break based on the targeting criteria associated with the scene segment. In some implementations, advertisement targeting criteria may accompany the content items. The provided targeting criteria can then be used to identify which advertisements are suited to the received content item(s). Access to the identified second content items is provided for presentation or storage on a device (406). In some implementations, the second content items are provided with the segmented first content item by advertisement provider 201 and/or content provider 203 to a user device 205.

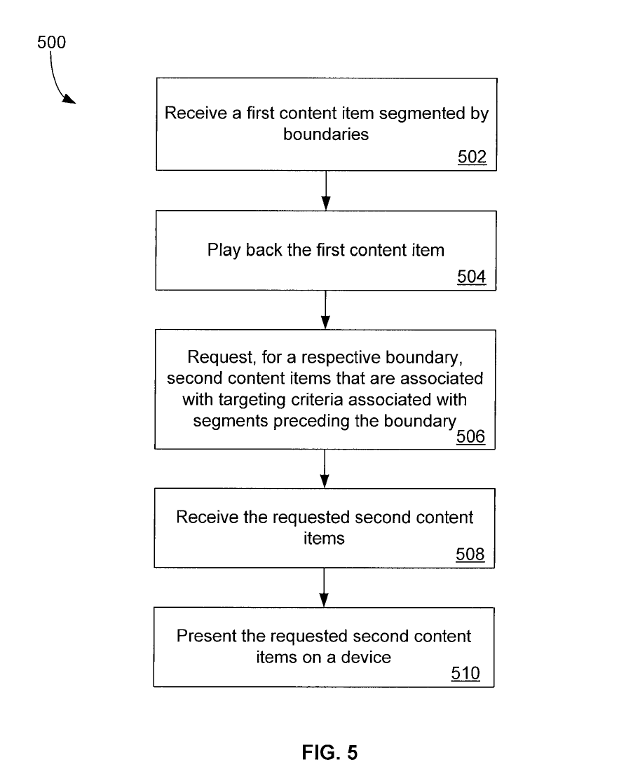

FIG. 5 is a flow diagram illustrating an example process 500 for presenting requested content.

A first content item that has been segmented by boundaries is received (502). The first content item is played back (504). For example, the user device 205 may receive and play a content item in a media player module. In some implementations, the playback may occur in a webpage. Playback may be user-initiated or can begin automatically based on some signal (e.g., webpage loading).

One or more second content items (e.g., advertisements) are requested for a boundary based on targeting criteria associated with any number of the segments preceding or succeeding the boundary (506). For example, during playback, before playback reaches a certain boundary, the user device 205 can read the targeting criteria for the preceding segments and request advertisements relevant to these targeting criteria. In some implementations, advertisements are requested based on only the targeting criteria for the segment immediately preceding the boundary. The request can be sent to a provider of advertising content (e.g., an advertisement provider 201). The provider of advertising material identifies one or more advertisements relevant to the targeting criteria and sends the advertisements to the user device 205.

The requested second content items are received by the user device 205 (508). In some implementations, further processing may occur before the received advertisements are presented. For example, the user device 205 may determine whether or not the received advertisements adhere to a particular time schedule (e.g., determine whether the advertisements fit into the slotted time). As such, the processing may include comparing metadata associated with the advertisements to metadata associated with the content item or the boundaries.

The requested second content items are presented to the user (5 10). In some implementations, depending on the particular advertisement, the advertisements can be presented on-screen, in proximity to the content item, or in-stream. The second content items can be displayed on a display device of the user device 205, for example.

Process 500, as described above, includes providing the user device with the targeting criteria of the first content item. In some implementations, the user device is not provided with, or does not have access to, the targeting criteria of the first content item. Instead, the targeting criteria remains with the content provider and/or the advertisement provider. To request one or more advertisement for a content item, the user device can send a request that includes an identifier of the first content item and data regarding the boundary or ad slot for which the advertisements is being requested. The advertisement provider receives the request and fulfills it by identifying and sending the requested advertisements to the user device.

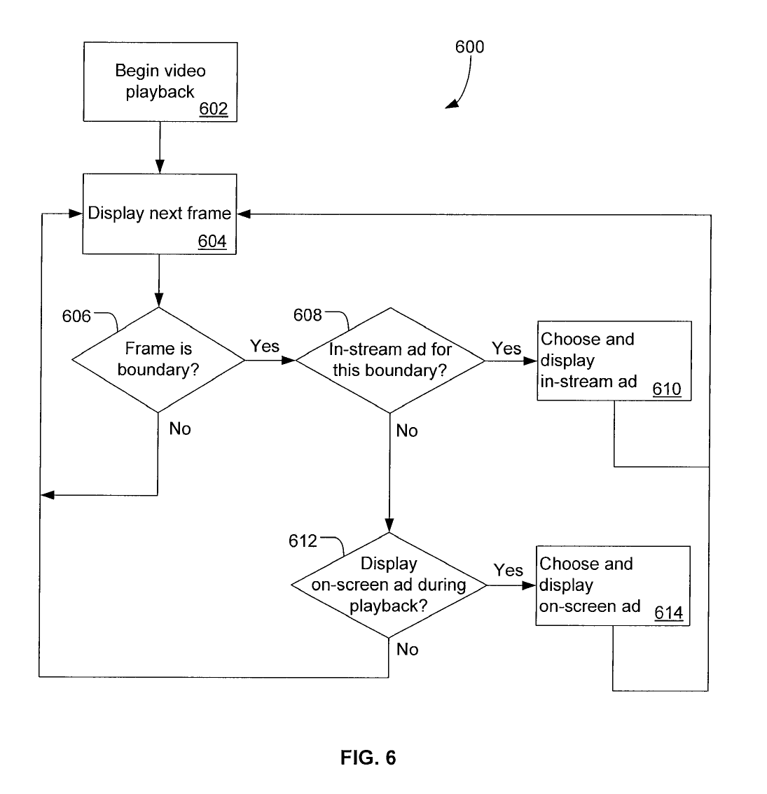

FIG. 6 is a flow diagram illustrating an example process 600 for selecting a mode of display for pre-selected content. For convenience, the process 600 will be described with reference to a computer system (e.g., a user device 205) that performs the process. The pre-selected content may include text, audio, video, advertisements, configuration parameters, documents, video files published on the Internet, television programs, podcasts, video podcasts, live or recorded talk shows, video voicemail, segments of a video conversation, and other distributable resources. The example process depicted in FIG. 6 generally relates to presenting advertisements in, on, or near video content items, however, presenting other media content is possible.

In some implementations, the user device may acquire video content and related metadata. As described above in reference to FIGS. 2-3, the acquired material may be have previously been parsed for content to detect boundaries and to determine relevant associated content. The boundaries may be used as a basis for determining content related in the scenes of the video content item. In some implementations, detecting boundaries and determining relevant content for display may be performed in a single pass over the video content.

The process 600 begins with playback of the video content item (602). Playback may be user-initiated or automatic based on system data.

A frame of the video content item is loaded (604). The individual frames can be loaded into the media player or website as playback proceeds. Multiple frames can be shown in sequence to produce a moving image as perceived by a user viewing the video content item as it is played back.

The user device determines whether or not a particular frame is a boundary (e.g., a scene boundary or breakpoint) (606). If the frame is not a boundary, the next frame is displayed (604). If the frame is a boundary, the user device checks whether one or more in-stream advertisements should be presented at the boundary (608). If an in-stream ad should be presented, the user device selects an advertisement based on targeting criteria relevant to that point in time in the video content item. In some implementations, this can include the targeting criteria available since the immediately-previous boundary (i.e., associated with the immediately preceding segment), or some or all of the targeting criteria relevant before this boundary. In some implementations, the targeting criteria relevant to the content as a whole (e.g., content title) may also be used. The advertisement is displayed in-stream (610). For example, the advertisement replaces the video content in the video player for some period of time. As another example, the advertisement is presented between segments of the video content.

If an in-stream advertisement is unavailable for this breakpoint, the user device checks whether to display or change an on-screen advertisement (612). For example, the decision might be based on the last time an on-screen advertisement was displayed or changed, the availability of new advertisements, or an upper limit on the number of advertisements to be displayed with this content item.

If the user device determines not to replace the on-screen advertisement, the next video frame is displayed (604) and the frame determination process begins again.

If the user device determines to replace the on-screen advertisements, the user device selects an advertisement based on the targeting criteria relevant to that point in time and displays the advertisements (614). In some implementations this can include the targeting criteria available since the immediately-previous boundary (i.e., associated with the immediately preceding segment), or some or all of the targeting criteria relevant before this boundary. In some implementations, the targeting criteria relevant to the content as a whole (e.g., content title) may also be used.

In some implementations, on-screen advertisement displays need not be static throughout a scene. Accordingly, the advertisements may change over time with or without scene breaks. For example, the user interface (e.g., hosting website) may determine when to display each advertisement based on criteria other than targeting information. As another example, a selection of advertisements can be scrolled. The selection of advertisements to be scrolled during a segment can be selected at or before boundary before the segment.

In some implementations, the boundaries determined by the user device need not match those determined by the content analysis, as described in reference to FIG. 3. For example, the user device can abstain from requesting advertisements at a boundary determined by the content analysis. As another example, the user device can determine a boundary at a time position in the video that is not any of the time positions determined as boundaries based on the content analysis.

In some implementations, the user device can look ahead in the video for upcoming boundaries. If upcoming boundaries are detected, the user device can check if in-stream or on-screen advertisements should be presented at those boundaries, and retrieve advertisements for those boundaries as needed.

In some implementations, the content is provided to an advertisement provider at some time before a user chooses to view the content. In some other implementations, the advertisement provider may retrieve and process the data at the time the user chooses to view the content.

In some implementations, the processes described above in reference to FIGS. 3-6 can be adapted for television technology. Interstitial advertisements for linear television can be determined in advance of airtime. For example, a linear television operator system or a content provider can provide advertisement slot information and targeting criteria to an advertisement provider. The advertisement provider identifies the ad content and provides the ad content or identifiers of the ad content to the linear television operator system or the content provider. The television operator system or content provider can composite the ad content with the content item and then provide access to the composited content item to users.

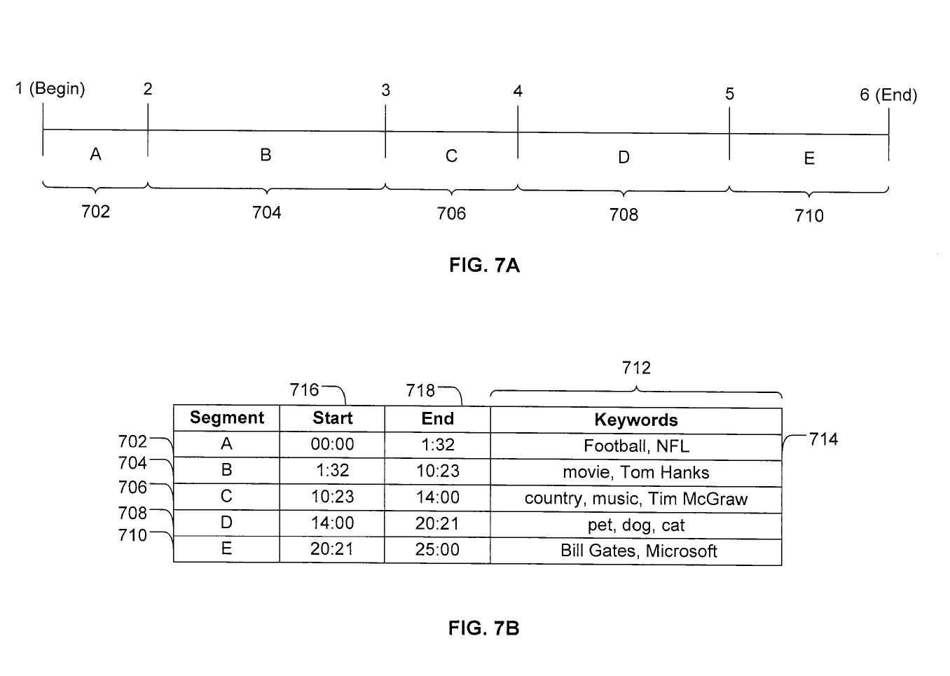

FIG. 7A is an example timeline illustrating segments (A-E) divided into time slots. The segments include A (702), B (704), C (706), D (708), and E (710). The combined segments correspond to content such as videos, television programs, audio-only content, caption data, and other media. The segments can be divided according to subject matter, programming schedule, keyword coverage, programming metadata, etc.

In some implementations, the timeline may represent one or more video content items divided into segments, each including ad spots. In such an implementation, each segment may be considered to be a video content item itself. Relevant ads may be determined on the basis of a particular video segment or both the particular video segment (e.g., weighted more) and the video content item as a whole (e.g., weighted less). Similarly, relevancy information may be weighted based on a timing of transcriptions within a segment or within a video content item. For example, a topic that is temporally closer to an ad spot may be weighted more than a topic or topics (perhaps in the same segment), that is temporally farther from the ad spot.

As shown, the segments include boundaries (1-6) where other content such as advertisements can be placed according to relevancy. For example, the boundaries occurring immediately after segment B may be associated with content related to segment B. In some implementation, the boundaries between time slots may include multiple ads or ad slots related to some, none, or all of the depicted segments (A-E).

Accordingly, and in some implementations, content boundaries can denote where a subject matter change occurs. FIG. 7B is an example table corresponding to the segments (A-E) illustrated in the implementation of FIG. 7. Here, the segments (A-E) have been analyzed to determine targeting criteria (e.g., keywords) related to each segment. For example, the advertisement provider 201 can perform an analysis to determine targeting criteria, for example, the keywords shown in the keyword column 712. In some implementations, the content provider 203 may have simply provided the advertisement provider 201 with the keywords for a particular segment.

The keywords may be used to identify types of ad content appropriate for a particular segment. For example, segment A 702 shows a time slot associated with the keywords “Football” and “NFL” 714. The advertisement provider can use the keywords 714 to search for advertisements in available repositories. For example, targeting criteria (e.g., the keywords football and NFL) can be used to identify one or more content items (e.g., advertisements) related to segment A. The identified advertisements can be presented to a client at the boundary (2) between segment A and B.

In some implementations, the table illustrated in FIG. 7B is an example of a data structure that can be used to store metadata indicating the lengths of the segments in the content item (and by implication, the locations of the boundary positions). For example, start and end times 716 and 718, respectively, indicate the times in a content item when a segment begins and when a segment ends.

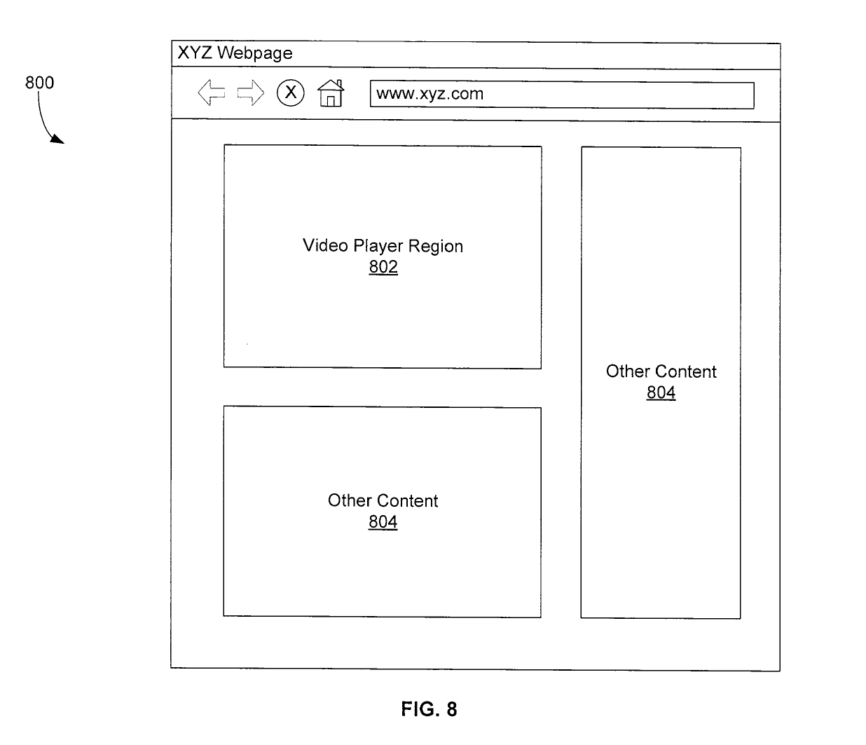

FIG. 8 is an example user interface 800 illustrating advertising content displayed on a screen with video content. The user interface 800 illustrates an example web browser user interface. However, the content shown in the user interface 800 can be presented in a webpage, an MP3 player, a streaming audio player, a streaming video player, a television, a computer, a mobile device, etc. The content shown in the user interface 800 may be provided by advertisement provider 102, content provider 104, another networked device, or some combination of those providers.

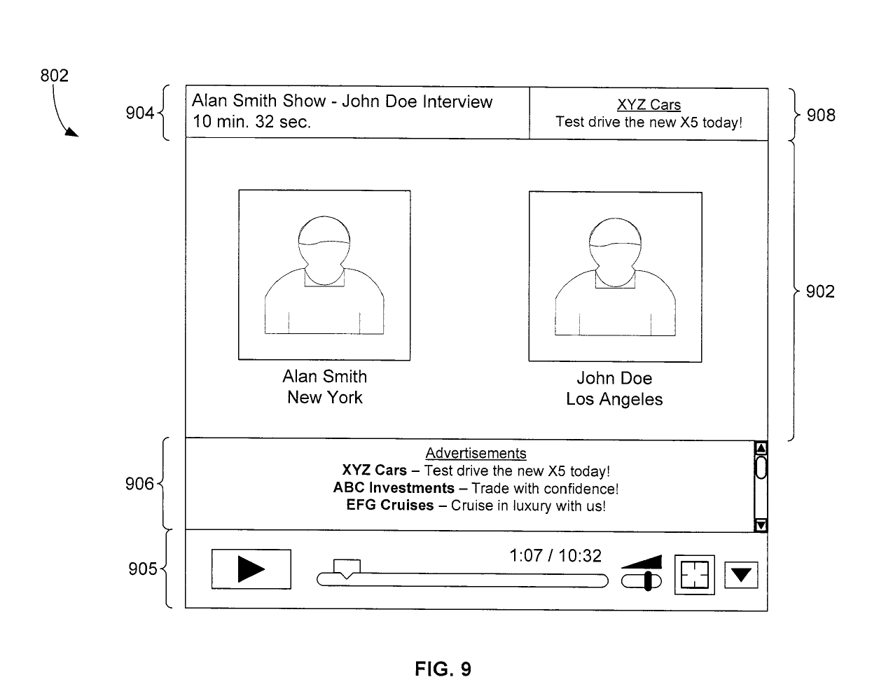

As shown, the user interface 800 includes a video player region 802 and one or more “other content” regions 804. The video display region 802 may include a media player for presenting text, images, video, or audio, or any combination thereof. An example of what can be shown in the video display region 802 is described in further detail below in relation to FIG. 9.

The other content regions 804 may display links, third party add-ins (e.g., search controls, download buttons, etc.), video and audio clips (e.g., graphics), help instructions (e.g., text, html, pop-up controls, etc.), and advertisements (e.g., banner ads, flash-based video/audio ads, scrolling ads, etc.).

The other content can be related to the content displayed in the video player region 802. For example, boundaries, targeting criteria, and other metadata related to the video player content may have been used to determine the other content 804. In some implementations, the other content is not related to the content in the video player region 802.

The other content region 804 can be in proximity to the video player region 802 during the presentation of video or audio content in the region 802. For example, the other content region 804 can be adjacent to the video display region 802, either above, below, or to the side of the video display region 802. For example, the user interface 800 may include an add-on, such as a stock ticker with text advertisements. The stock ticker can be presented in the other content region 804.

FIG. 9 illustrates an example user interface that can be displayed in a video player region 802. Content items, such as video, audio, and so forth can be displayed in the video player region 802. The region 802 includes a content display portion 902 for displaying a content item, a portion 904 for displaying information (e.g., title, running time, etc.) about the content item, player controls 905 (e.g., volume adjustment, full-screen mode, play/pause button, progress bar and slider, option menu, etc.), an advertisement display portion 908, and a multi-purpose portion 906 that can be used to display various content (e.g., advertisements, closed-captions/subtitles/transcript of the content item, related links, etc.).

As shown, the content shown represents a video (or audio) interview occurring between a person located in New York City, N.Y. and a person located in Los Angeles, California. The interview is displayed in the content display portion 902 of the region 802.

The region 802 may be presented as a stream, upon visiting a particular site hosting the interview, or after the execution of a downloaded file containing the interview or a link to the interview. As such, the region 802 may display additional content (e.g., ad content) that relates to the content shown in the video interview. For example, the additional content may change according to what is displayed in the region 802. The additional content can be substantially available as content from the content provider 104 and/or the advertisement provider 102.

An on-screen advertisement is displayed in the multi-purpose portion 906. An additional on-screen ad is displayed in the advertisement display portion 908. In some implementations, on-screen advertisements may include video, text, animated images, still images, or some combination thereof.

In some implementations, the content display portion 902 can display advertisements targeted to audio-only content, such as ads capable of being displayed in-stream with a podcast or web monitored radio broadcasts. For example, the advertisement provider 102 may provide interstitial advertisements, sound bytes, or news information in the audio stream of music or disc jockey conversations.

In some implementations, the progress bar in the player controls 905 also shows the positions of the interstitial ad slots in the content item being played.

Although the above implementations describe targeting advertisements to content items that include video content and presenting such advertisements, the above implementations are applicable to other types of content items and to the targeting of content other than advertisements to content items. For example, in some implementations, a text advertisement, an image advertisement, an audio-only advertisement, or other content, etc. might be presented with a video content item. Thus, although the format of the ad content may match that of the video content item with which it is served, the format of the ad need not match that of the video content item. The ad content may be rendered in the same screen position as the video content, or in a different screen position (e.g., adjacent to the video content as illustrated in FIG. 8). A video ad may include video components, as well as additional components (e.g., text, audio, etc.). Such additional components may be rendered on the same display as the video components, and/or on some other output means of the user device. Similarly, video ads may be played with non-video content items (e.g., a video ad with no audio can be played with an audio-only content item).

In some implementations, the content item can be an audio content item (e.g., music file, audio podcast, streaming radio, etc.) and advertisements of various formats can be presented with the audio content item. For example, audio-only advertisements can be presented in-stream with the playback of the audio content item. If the audio content item is played in an on-screen audio player module (e.g., a Flash-based audio player module embedded in a webpage), on-screen advertisements can be presented in proximity to the player module. Further, if the player module can display video as well as play back audio, video advertisements can be presented in-stream with the playback of the audio content item.

Further, in some implementations, the content that is identified for presentation based on the targeting criteria (advertisements in the implementations described above) need not be advertisements. The identified content can include non-advertisement content items that are relevant to the original content item in some way. For example, for a respective boundary in a video content item, other videos (that are not necessarily advertisements) relevant to the targeting criteria of one or more segments preceding the boundary can be identified. Information (e.g., a sample frame, title, running time, etc.) and the links to the identified videos can be presented in proximity to the video content item as related videos. In these implementations, the related content provider can be considered a second content provider that includes a content analyzer, boundary module, and a targeting criteria module.

The implementations above were described in reference to a client-server system architecture. It should be appreciated, however, that system architectures other than a client-server architecture can be used. For example, the system architecture can be a peer-to-peer architecture.

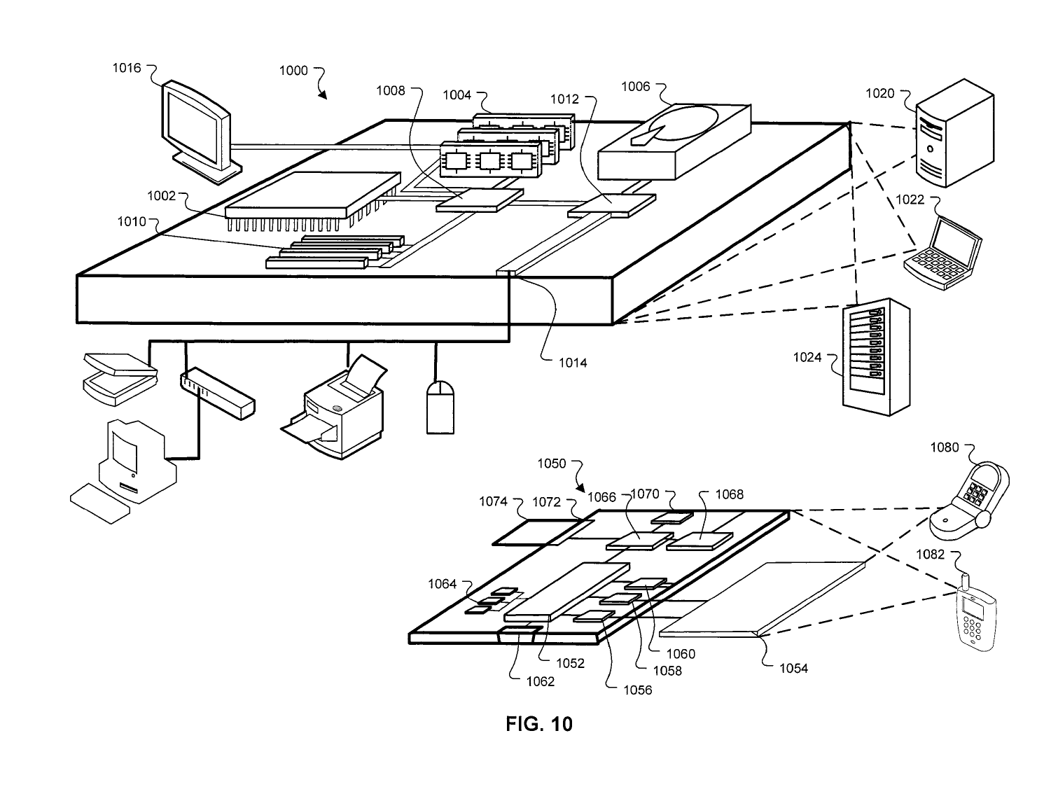

FIG. 10 shows an example of a generic computer device 1000 and a generic mobile computer device 1050, which may be used with the techniques described above. Computing device 1000 is intended to represent various forms of digital computers, such as laptops, desktops, workstations, personal digital assistants, television set-top boxes, servers, blade servers, mainframes, and other appropriate computers. Computing device 1050 is intended to represent various forms of mobile devices, such as personal digital assistants, cellular telephones, smartphones, and other similar computing devices. The components shown here, their connections and relationships, and their functions, are meant to be exemplary only, and are not meant to limit the implementations described and/or the claims.

Computing device 1000 includes a processor 1002, memory 1004, a storage device 1006, a high-speed interface 1008 connecting to memory 1004 and high-speed expansion ports 1010, and a low speed interface 1012 connecting to low speed bus 1014 and storage device 1006. Each of the components 1002, 1004, 1006, 1008, 1010, and 1012, are interconnected using various buses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high speed interface 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, memory on processor 1002, or a propagated signal.

The high speed controller 1008 manages bandwidth-intensive operations for the computing device 1000, while the low speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed expansion port 1014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT (Thin-Film-Transistor Liquid Crystal Display) display or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 1050. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, memory on processor 1052, or a propagated signal that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, WiFi, or other such transceiver (not shown). In addition, GPS (Global Positioning System) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smartphone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. For example, various forms of the flows shown above may be used, with steps re-ordered, added, or removed. Other implementations are within the scope of the following claims.

What is claimed is:

1. A method, comprising:
receiving a first content item;
determining one or more content boundaries for the first content item, the content boundaries segmenting the first content item into a plurality of segments;
determining, for at least one segment, one or more respective targeting criteria;
identifying one or more second content items for a respective content boundary based on the targeting criteria for one or more of the segments preceding or succeeding the respective content boundary; and
providing access to the identified second content items for presentation or storage on a device.

2. The method of claim 1, wherein the first content item comprises video data.

3. The method of claim 2, wherein determining one or more content boundaries comprises determining one or more content boundaries based on the video data of the first content item.

4. The method of claim 2, wherein determining targeting criteria for a respective segment comprises determining one or more targeting criteria for the respective segment based on a respective video data within the respective segment.

5. The method of claim 4, wherein determining one or more targeting criteria for the respective segment comprises applying automatic object recognition to the respective video data within the respective segment to identify one or more targeting criteria from recognized objects associated with the respective video data.

6. The method of claim 1, wherein the first content item comprises audio data.

7. The method of claim 6, wherein determining one or more content boundaries comprises determining one or more content boundaries based on the audio data of the first content item.

8. The method of claim 6, wherein determining targeting criteria for a respective segment comprises determining one or more targeting criteria for the respective segment based on a respective audio data within the respective segment.

9. The method of claim 8, wherein determining one or more targeting criteria for the respective segment comprises applying automatic speech recognition to the respective audio data within the respective segment to identify one or more targeting criteria from determined speech associated with the respective audio data.

10. The method of claim 1, wherein the first content item comprises timecoded metadata.

11. The method of claim 10, wherein the timecoded metadata comprises subtitles data.

12. The method of claim 10, wherein determining targeting criteria for a respective segment comprises determining one or more targeting criteria for the respective segment based on timecoded metadata associated with the respective segment.

13. The method of claim 1, further comprising analyzing the first content item; and wherein:
determining one or more content boundaries comprises determining one or more content boundaries based at least on the analyzing; and
determining one or more respective targeting criteria comprises determining one or more respective targeting criteria based at least on the analyzing.

14. The method of claim 1, wherein the second content items comprise one or more advertisements.

15. A system, comprising:
one or more processors; and
a computer-readable medium storing instructions for execution by the one or more processors, the instructions comprising instructions to:
receive a first content item;
determine one or more content boundaries for the first content item, the content boundaries segmenting the first content item into a plurality of segments;
determine, for at least one segment, one or more respective targeting criteria;
identify one or more second content items for a respective content boundary based on the targeting criteria for one or more of the segments preceding or succeeding the respective content boundary; and
provide access to the identified second content items for presentation or storage on a device.

16. A computer program product, encoded on a tangible program carrier, operable to cause a data processing apparatus to perform operations comprising:
receiving a first content item;
determining one or more content boundaries for the first content item, the content boundaries segmenting the first content item into a plurality of segments;
determining, for at least one segment, one or more respective targeting criteria;
identifying one or more second content items for a respective content boundary based on the targeting criteria for one or more of the segments preceding or succeeding the respective content boundary; and
providing access to the identified second content items for presentation or storage on a device.

17. A system, comprising:
means for receiving a first content item;
means for determining one or more content boundaries for the first content item, the content boundaries segmenting the first content item into a plurality of segments;
means for determining, at least one segment, one or more respective targeting criteria;
means for identifying one or more second content items for a respective content boundary based on the targeting criteria for one or more of the segments preceding or succeeding the respective content boundary; and
means for providing access to the identified second content items for presentation or storage on a device.

18. A method, comprising:
receiving a first content item, the first content item segmented into a plurality of segments by one or more content boundaries, at least one segment associated with respective targeting criteria;
identifying, for a respective content boundary, one or more second content items based on the respective advertisement targeting criteria associated with one or more of the segments preceding or succeeding the respective content boundary; and
providing access to the identified second content items for presentation or storage on a device.

19. A method, comprising:
receiving a first content item, the first content item segmented into a plurality of segments by one or more content boundaries, at least one segment associated with respective targeting criteria;
presenting the first content item;
requesting, for a respective content boundary, one or more second content items associated with respective targeting criteria of one or more of the segments preceding or succeeding the respective content boundary;
receiving the second content items; and
presenting on a device the second content items after the content boundary is reached during the presenting of the first content item.

20. The method of claim 19, wherein presenting the second content items comprises presenting on the device the second content items in-stream with the first content item during the presenting of the first content item.

21. The method of claim 19, wherein:
presenting on the device the first content item comprises presenting the first content item in a display region within a user interface; and
presenting on the device the second content items comprises presenting the second content items in the user interface, in proximity to the display region, during the presenting of the first content item.

22. The method of claim 19, wherein the second content items comprise one or more advertisements.
